(19) United States
(12) Patent Application Publication
(10) Pub. No.: US 2020/0050333 A1
(43) Pub. Date: Feb. 13, 2020

(54) IoT Application Solution Support Assistant Graphical User Interface

(71) Applicant: SAP SE, Walldorf (DE)

(72) Inventors: Timo Hoyer, San Francisco, CA (US); Riccardo Spina, Burlingame, CA (US); Dirk Wodtke, Aptos, CA (US)

(21) Appl. No.: 16/057,632

(22) Filed: Aug. 7, 2018

(51) Int. Cl. G06F 3/0486; G06F 3/0481; G06Q 10/08

(52) U.S. Cl. CPC G06F 3/0486; G06Q 10/0833; G06F 3/04817

(57) ABSTRACT

A graphical user interface is rendered that includes a plurality of cards and a launch pad. Each of the cards includes at least one graphical user interface element each with a corresponding information element. Thereafter, first user-generated input is received via the graphical user interface selecting one of the graphical user interface elements. In addition, second user-generated input is received via the graphical user interface selecting the launch pad. In some variations, the first user-generated input and the second user-generated input form a combined gesture. Subsequently, a new card is displayed in the launch pad in the graphical user interface. The new card includes additional information for the information element corresponding to the selected graphical user interface element.

### TECHNICAL FIELD

The subject matter described herein relates to advanced graphical user interfaces for providing support for Internet of Things (IoT) applications.

### BACKGROUND

With software systems providing supply chain management (SCM) support, operations managers have to deal with a complexity of issues that can occur during a lifecycle of a product or device delivery. Consecutive issues can worsen a problem, delay delivery, and the like. With SCM, there can be a number of different types of alerts, notifications, business objects, business contacts a user needs to consume and interact with daily on a frequent basis. Currently, users have to manually identify how to solve issues and use best of their knowledge and experience. Once a notification is sent that a situation has occurred, a user typically does not have all the context, knowledge, experience and insight into circumstances required to make an informed decision how to resolve the situation.

### SUMMARY

A graphical user interface is rendered that includes a plurality of cards and a launch pad. Each of the cards includes at least one graphical user interface element each with a corresponding information element. Thereafter, first user-generated input is received via the graphical user interface selecting one of the graphical user interface elements. In addition, second user-generated input is received via the graphical user interface selecting the launch pad. In some variations, the first user-generated input and the second user-generated input form a combined gesture. Subsequently, a new card is displayed in the launch pad in the graphical user interface. The new card includes additional information for the information element corresponding to the selected graphical user interface element.

Data can be received from each of a plurality of computing nodes that characterize aspects of a supply chain. In such cases, the information elements can display information related to the processes and goods forming part of the supply chain.

The combined gesture can be a drag and drop gesture.

Third user-generated input can be received via the graphical user interface selecting a second of the graphical user interface elements and such second graphical user interface element cannot be moved. Information can then be displayed that corresponds to an information element corresponding to the selected second graphical user interface element. Such information is displayed in a window overlaying a card in which the selected second graphical user interface element resides. The second graphical user interface element cannot be moved due to the launch pad being filled with the new card and/or because there is only limited additional information associated with the corresponding information element.

An icon graphical user interface element can be displayed in the graphical user interface which visually changes when additional supply chain management event information becomes available. Fourth user-generated input can be received via the graphical user interface selecting the icon graphical user interface element. An event resolution window can be displayed that characterizes the additional supply chain event information. The event resolution window can include at least one graphical user interface element which, when activated or otherwise utilized by a user, initiates at least one resolution relating to the additional supply chain event information.

Non-transitory computer program products (i.e., physically embodied computer program products) are also described that store instructions, which when executed by one or more data processors of one or more computing systems, cause at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The subject matter described herein provides many technical advantages. For example, the current subject matter provides enhanced graphical user interfaces that provided for enhanced user interactions allowing SCM operation managers to more readily obtain relevant information.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a system architecture diagram;

FIG. 2 is a first view of a graphical user interface;

FIG. 3 is a second view of a graphical user interface;

FIG. 4 is a third view of a graphical user interface;

FIG. 5 is a fourth view of a graphical user interface;

FIG. 6 is a fifth view of a graphical user interface;

FIG. 7 is a sixth view of a graphical user interface;

FIG. 8 is a seventh view of a graphical user interface;

FIG. 9 is a process flow diagram illustrating a method of displaying and interacting with information displayed in a graphical user interface as in any of FIGS. 2-8; and

FIG. 10 is a system diagram illustrating a computing device for implementing aspects of the subject matter described herein.

Like reference symbols in the various drawings indicate like elements.

### DETAILED DESCRIPTION

The current subject matter is directed to graphical user interfaces and related systems, methods, and articles for an issue solution assistant readily accessible and globally in Internet of Things (IoT) applications. These advances allow users to obtain summarized context to changing situations (i.e. issues, anomalies, other special supply chain phases, etc.) or in ordinary conditions as well. The systems implementing the graphical user interfaces gather data in the background, that can be presented in a panel that can be invoked on the top right of the screen with the click of an icon. This summarized data set can contain key facts, KPIs, process view instances or other artifacts of relevance for the user's role to help facilitate more efficient SCM transactions and the like.

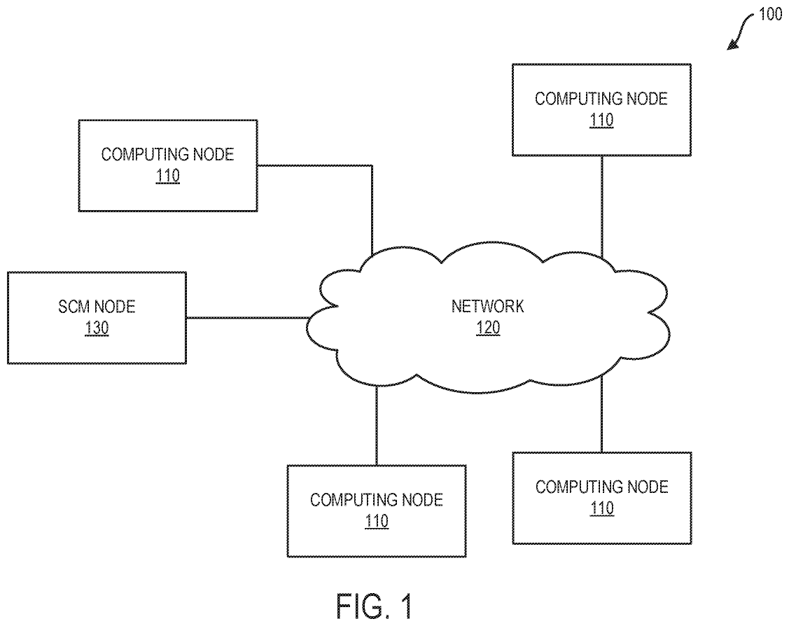

FIG. 1 is a diagram illustrating a computing environment 100 in which there are a plurality of computing nodes 110 that interact with each other over a network 120 or peer to peer or via other communication mechanisms to execute a software system comprising one or more software applications. The computing nodes 110 can collectively be various computing devices that assist with the management and characterization of a supply chain across multiple physical sites and the like. The computing nodes 110 can be one or more of Internet of Things (IoT) devices, a mobile computing device (e.g., tablet computer, mobile phone, etc.), client computers (e.g., laptops, desktops, etc.) or servers (e.g., web servers, application servers, etc.) or data storage devices (e.g., cloud-computing data sources, databases, etc.). Further, each computing node 110 comprises memory and at least one data processor for executing instructions loaded into the memory. The computing environment 100 can additionally include a supply chain management (SCM) node 130 that, as will be described in further detail below, can cause various graphical user interface view to be rendered on one of the computing nodes 110 (or alternatively on a different remote computing device). It will be appreciated that other implementations can utilize SCM nodes 130. The SCM node 130 can, in some variations, be a dedicated computing device executing graphical user interface software while, in other cases, the SCM node 130 can be used to execute a distributed software system. The architecture of FIG. 1 can include or otherwise form part of a system architecture such as the SAP LEONARDO IT BRIDGE architecture.

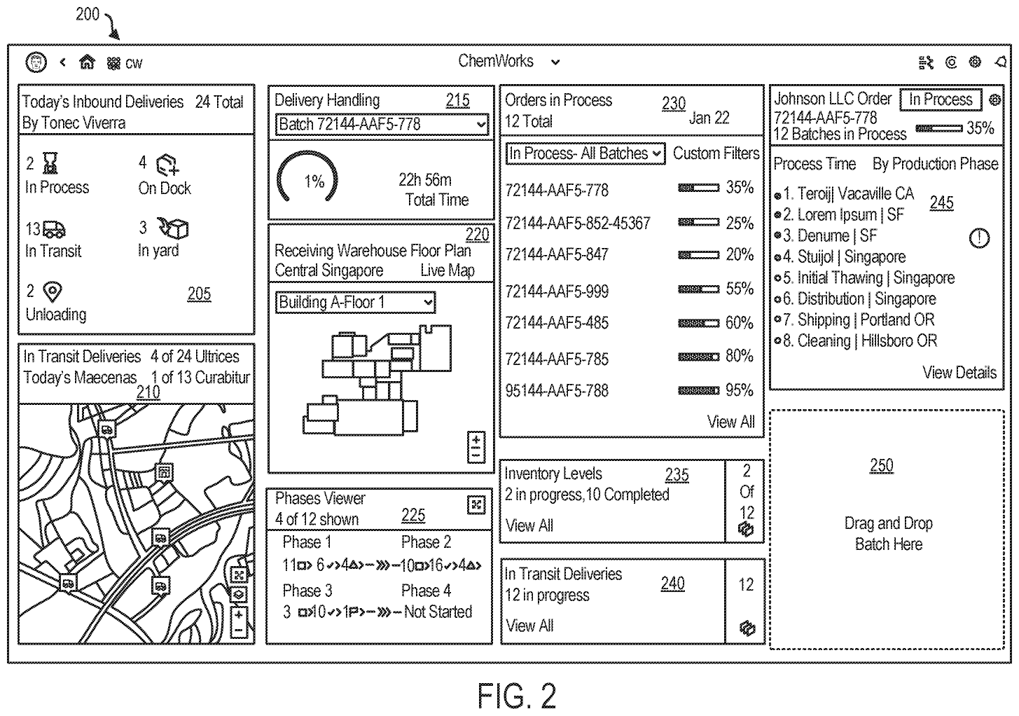

FIGS. 2-8 are various views 200-800 of a graphical user interface that can be provided by an SCM node 130 (i.e., the SCM node 130 can cause a graphical user interface to be rendered on a computing device 110 connected to the network 120) as in FIG. 1. As shown in the view 200, a graphical user interface is provided that includes a plurality of cards 205-245 that each characterize aspects of a supply chain. These cards 205-245 can be moved within such graphical user interface through drag and drop operations and/or can be resized (causing a size of other cards 205-245 to adjust accordingly). In addition, each card can contain graphical user interface elements 202 along with corresponding information elements (IEs) (i.e., the information elements can be integral with and/or spatially adjacent to the graphical user interface elements) that visually display information characterizing some aspect of the supply chain. The information elements can take various forms including alphanumeric text, maps, charts, infographics, and the like.

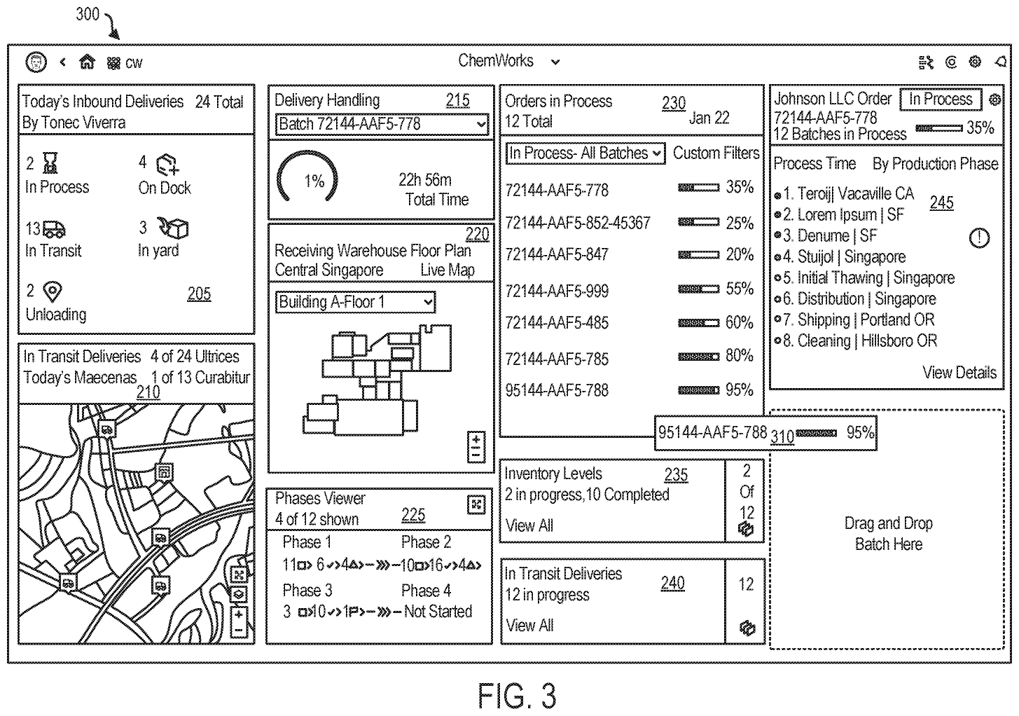

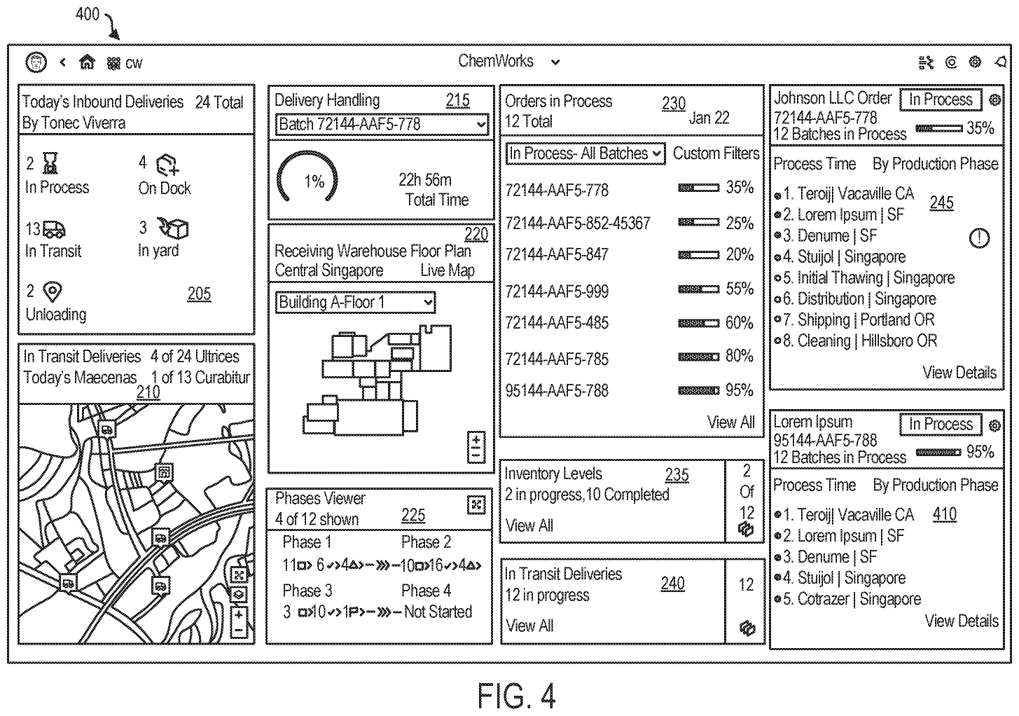

The graphical user interface 200 can additionally include a launch pad 250 which, as described in further detail below, can provide additional complimentary information about one of the information elements. For example, and with reference to FIG. 3, a user can drag and drop one of the information elements (via its corresponding graphical user interface element 310) from its corresponding card 235 to the launch pad 250 which, in turn, as shown in FIG. 4, causes a new persistent card 410 to be rendered in the graphical user interface 200. Such card 410 provides additional information about the information element corresponding to allow a user to obtain more context on such information element. Other types of gestures can be used to move the graphical user interface element 310 to the launch pad 250.

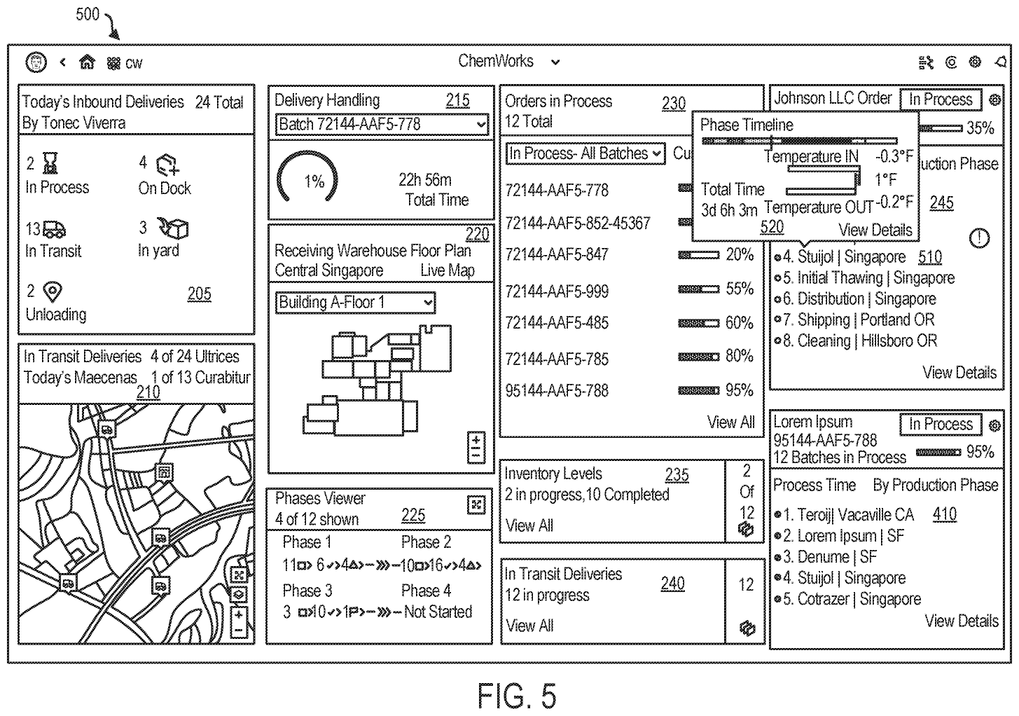

In some variations such as in FIG. 5, a graphical user interface element 510 for an information element can be activated (for example, by hovering over or selecting the graphical user interface element 510) which causes a card 520 to be overlaid over a portion of the card 245 in which the graphical user interface element 510 resides. Such an arrangement can be provided as a preview for this and other information elements and/or it can be provided in situations in which the card 520 cannot be moved to the launch pad 250. This situation might occur when there is already a card (e.g., card 410) in the launch pad 250 or there is not sufficient information associated with the information element to generate a new card at the launch pad 250.

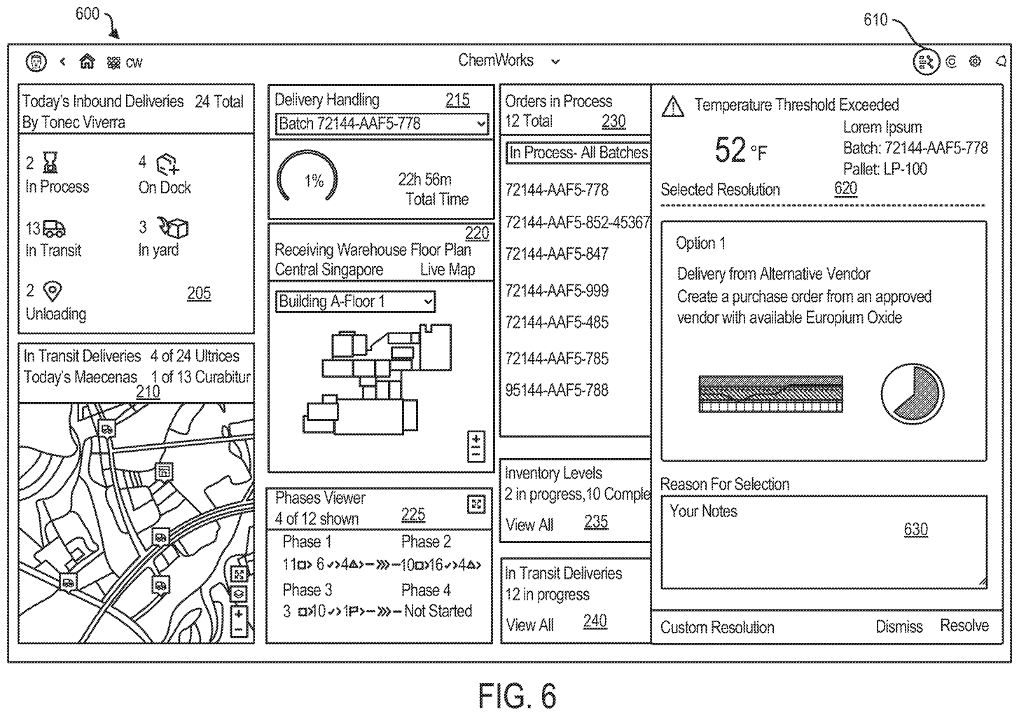

FIG. 6 illustrates a view 600 of the graphical user interface in which an icon graphical user interface element 610 (which can take various visual forms and is sometimes referred to simply as an icon 610). The icon 610, when activated, can be used to invoke a solution assistant view. The icon 610 can visually indicate by flashing, changing color, or initiating an animation sequence if there is refreshed context available for a certain of the information elements 202. Rather than needing to navigate away from the graphical user interface, selecting the icon 610 can cause a new window 620 to be displayed which contains additional relevant information (e.g., information about an event affecting the supply chain, etc.). Further, the new window 620 can include an input box 630 or other input box which allows a user to address how to resolve an SCM issue identified in the new window 620 (either through initiating a computer-based process or providing instructions on how to resolve).

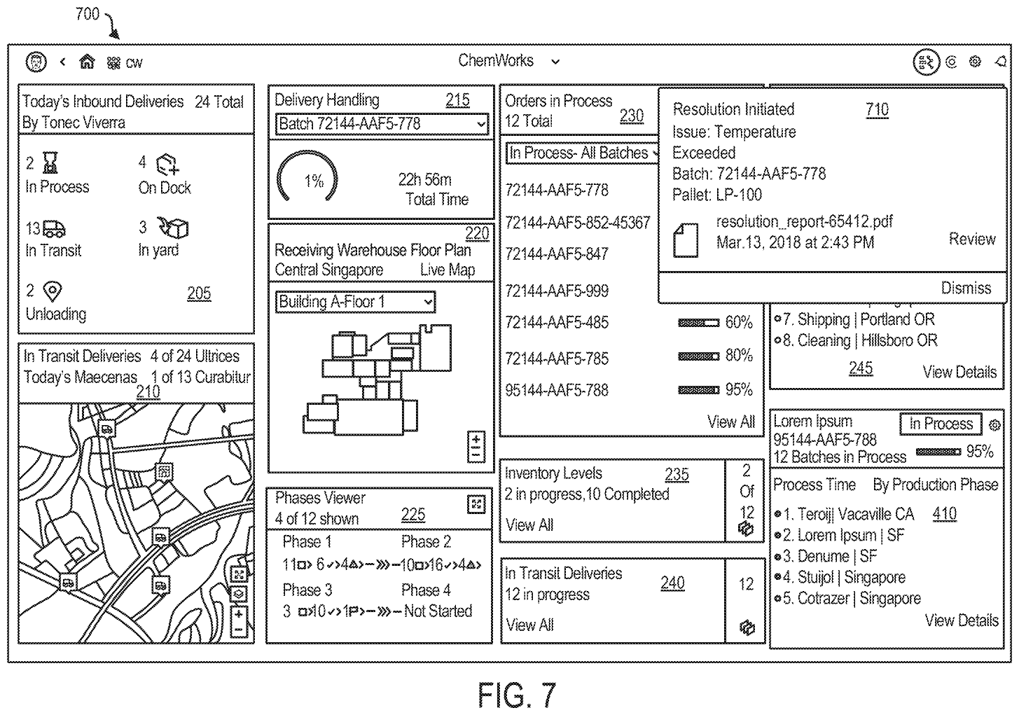

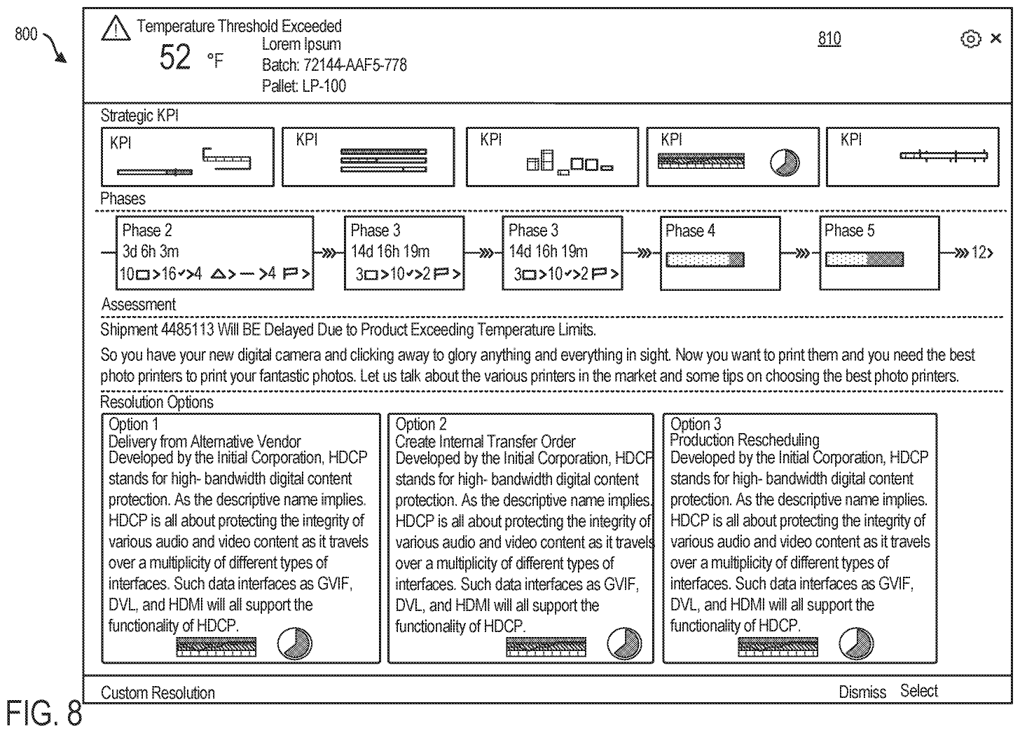

The graphical user interface can be updated as in FIG. 7 with a new card 710 indicating that a resolution has been initiated. In some cases, such as in diagram 800 of FIG. 8, the new window 620 can also be expanded to a larger view 800 that allows for a side by side comparison of resolution options. This full screen view 810 can also be dragged to a second monitor display so that resolutions, impact and issue can be compared side by side. Data accuracy will be ensured by implementing these annotations with so-called sockets that will update the graphical user interface holistically across all views.

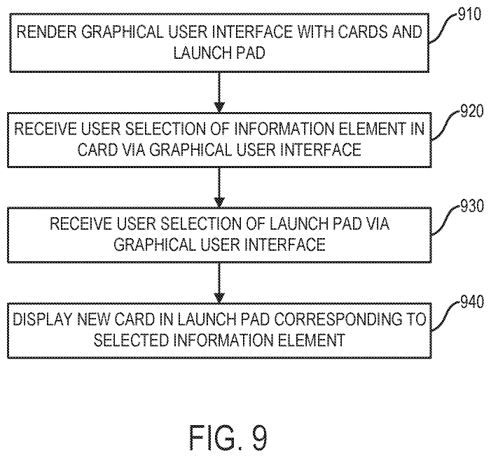

FIG. 9 is a process flow diagram 900 in which, at 910, a graphical user interface is rendered that includes a plurality of cards and a launch pad. Each of the cards includes at least one graphical user interface element each with a corresponding information element. Thereafter, at 920, first user-generated input is received via the graphical user interface selecting one of the graphical user interface elements. Further, at 930, second user-generated input is received via the graphical user interface selecting the launch pad such that the first user-generated input and the second user-generated input form a combined gesture. This action causes, at 940, a new card to be displayed in the launch pad in the graphical user interface that includes additional information for the information element corresponding to the selected graphical user interface element.

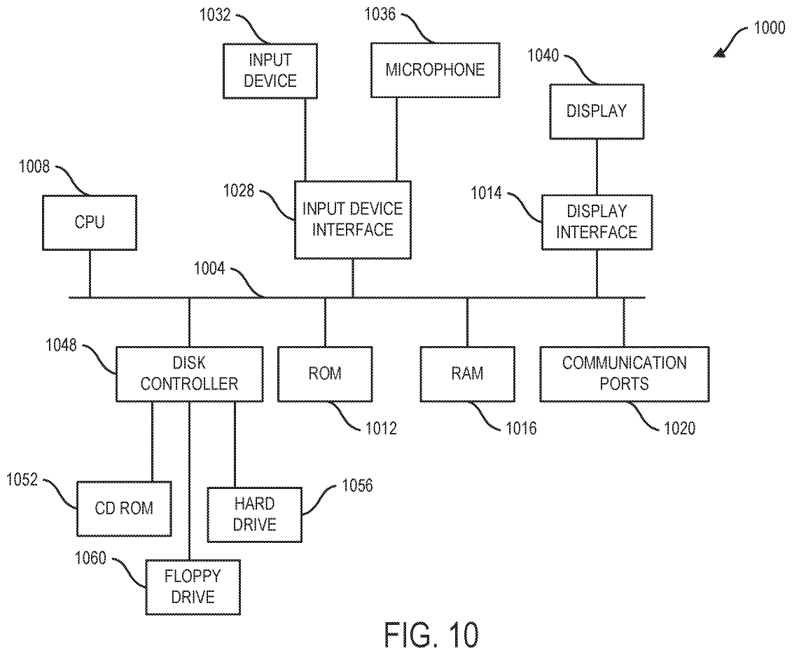

FIG. 10 is a diagram 1000 illustrating a sample computing device architecture for implementing various aspects described herein. A bus 1004 can serve as the information highway interconnecting the other illustrated components of the hardware. A processing system 1008 labeled CPU (central processing unit) (e.g., one or more computer processors/data processors at a given computer or at multiple computers), can perform calculations and logic operations required to execute a program. A non-transitory processor-readable storage medium, such as read only memory (ROM) 1012 and random access memory (RAM) 1016, can be in communication with the processing system 1008 and can include one or more programming instructions for the operations specified here. Optionally, program instructions can be stored on a non-transitory computer-readable storage medium such as a magnetic disk, optical disk, recordable memory device, flash memory, or other physical storage medium.

In one example, a disk controller 1048 can interface one or more optional disk drives to the system bus 1004. These disk drives can be external or internal floppy disk drives such as 1060, external or internal CD-ROM, CD-R, CD-RW or DVD, or solid state drives such as 1052, or external or internal hard drives 1056. As indicated previously, these various disk drives 1052, 1056, 1060 and disk controllers are optional devices. The system bus 1004 can also include at least one communication port 1020 to allow for communication with external devices either physically connected to the computing system or available externally through a wired or wireless network. In some cases, the communication port 1020 includes or otherwise comprises a network interface.

To provide for interaction with a user, the subject matter described herein can be implemented on a computing device having a display device 1040 (e.g., a CRT (cathode ray tube) or LCD (liquid crystal display) monitor) for displaying information obtained from the bus 1004 to the user and an input device 1032 such as keyboard and/or a pointing device (e.g., a mouse or a trackball) and/or a touchscreen by which the user can provide input to the computer. Other kinds of input devices 1032 can be used to provide for interaction with a user as well; for example, feedback provided to the user can be any form of sensory feedback (e.g., visual feedback, auditory feedback by way of a microphone 1036, or tactile feedback); and input from the user can be received in any form, including acoustic, speech, or tactile input. In the input device 1032 and the microphone 1036 can be coupled to and convey information via the bus 1004 by way of an input device interface 1028. Other computing devices, such as dedicated servers, can omit one or more of the display 1040 and display interface 1014, the input device 1032, the microphone 1036, and input device interface 1028.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) and/or a touch screen by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A computer-implemented method comprising:
rendering a graphical user interface comprising a plurality of cards and a launch pad, each of the cards comprising at least one graphical user interface element each with a corresponding information element;
receiving first user-generated input via the graphical user interface selecting one of the graphical user interface elements on a first of the plurality of cards;
receiving second user-generated input via the graphical user interface selecting the launch pad, wherein the first user-generated input and the second user-generated input form a combined gesture; and
displaying, in the launch pad in the graphical user interface, a new card comprising additional information for the information element corresponding to the selected graphical user interface element, the new card being displayed concurrently with the first card after completion of the combined gesture.

2. The method of claim 1 further comprising:
receiving data from each of a plurality of computing nodes that characterize aspects of a supply chain;
wherein the information elements corresponding to the cards display information related to processes and goods forming part of the supply chain.

3. The method of claim 1, wherein the combined gesture is a drag and drop gesture.

4. The method of claim 1 further comprising:
receiving third user-generated input via the graphical user interface selecting a second of the graphical user interface elements in a second card, wherein the second graphical user interface element cannot be moved;
displaying information corresponding to an information element corresponding to the selected second graphical user interface element in a window overlaying the second card.

5. The method of claim 4, wherein the second graphical user interface element cannot be moved due to the launch pad being filled with the new card.

6. The method of claim 4, wherein the second graphical user interface element cannot be moved because there is only limited additional information associated with the corresponding information element.

7. The method of claim 1 further comprising:
displaying, in the graphical user interface, an icon graphical user interface element which visually changes when additional supply chain management event information becomes available.

8. The method of claim 7 further comprising:
receiving fourth-user generated input via the graphical user interface selecting the icon graphical user interface element; and
displaying an event resolution window characterizing the additional supply chain event information.

9. The method of claim 8, wherein the event resolution window comprises at least one graphical user interface element which, when activated or otherwise utilized by a user, initiates at least one resolution relating to the additional supply chain event information.

10. A system comprising:
at least one programmable data processor; and
memory storing instructions which, when executed by the at least one programmable data processor, result in operations comprising:
rendering a graphical user interface comprising a plurality of cards and a launch pad, each of the cards comprising at least one graphical user interface element each with a corresponding information element;
receiving first user-generated input via the graphical user interface selecting one of the graphical user interface elements on a first of the plurality of cards;
receiving second user-generated input via the graphical user interface selecting the launch pad, wherein the first user-generated input and the second user-generated input form a combined gesture; and
displaying, in the launch pad in the graphical user interface, a new card comprising additional information for the information element corresponding to the selected graphical user interface element, the new card being displayed concurrently with the first card after completion of the combined gesture.

11. The system of claim 10, wherein the operations further comprise:
receiving data from each of a plurality of computing nodes that characterize aspects of a supply chain;
wherein the information elements display information related to processes and goods forming part of the supply chain.

12. The system of claim 10, wherein the combined gesture is a drag and drop gesture.

13. The system of claim 10, wherein the operations further comprise:
receiving third user-generated input via the graphical user interface selecting a second of the graphical user interface elements within a second card, wherein the second graphical user interface element cannot be moved;
displaying information corresponding to an information element corresponding to the selected second graphical user interface element in a window overlaying the second card.

14. The system of claim 13, wherein the second graphical user interface element cannot be moved due to the launch pad being filled with the new card.

15. The system of claim 13, wherein the second graphical user interface element cannot be moved because there is only limited additional information associated with the corresponding information element.

16. The system of claim 10, wherein the operations further comprise:
displaying, in the graphical user interface, an icon graphical user interface element which visually changes when additional supply chain management event information becomes available.

17. The system of claim 16, wherein the operations further comprise:
receiving fourth-user generated input via the graphical user interface selecting the icon graphical user interface element; and
displaying an event resolution window characterizing the additional supply chain event information.

18. The method of claim 17, wherein the event resolution window comprises at least one graphical user interface element which, when activated or otherwise utilized by a user, initiates at least one resolution relating to the additional supply chain event information.

19. A non-transitory computer program product storing instructions which, when executed by at least one programmable data processor, result in operations comprising:
rendering a graphical user interface comprising a plurality of cards and a launch pad, each of the cards comprising at least one graphical user interface element each with a corresponding information element;
receiving first user-generated input via the graphical user interface selecting one of the graphical user interface elements on a first of the plurality of cards;
receiving second user-generated input via the graphical user interface selecting the launch pad, wherein the first user-generated input and the second user-generated input form a combined gesture; and
displaying, in the launch pad in the graphical user interface, a new card comprising additional information for the information element corresponding to the selected graphical user interface element, the new card being displayed concurrently with the first card after completion of the combined gesture.

20. The non-transitory computer program product of claim 19, wherein the operations further comprise:
receiving data from each of a plurality of computing nodes that characterize aspects of a supply chain;
wherein the information elements display information related to the processes and goods forming part of the supply chain.
